(19) United States
(12) Patent Application Publication
(10) Pub. No.: US 2009/0039156 A1
(43) Pub. Date: Feb. 12, 2009

(54) Method for Authorized Granting of a Service and Device for Carrying out Said Method

(75) Inventors: Willi Brandli, Bergdietikon (CH); Bruno Wenger, Au (CH); Roger Cattin-Liebl, Grenchen (CH); Marcel Jacomet, Lengnau (CH); Lorenz Muller, Biel (CH); Alain Rollier, Steinen (CH)

Correspondence Address: LERNER GREENBERG STEMER LLP, P O BOX 2480, HOLLYWOOD, FL, 33022-2480, US

(73) Assignees: AXISONICS AG, Biel/Bienne (CH); SIEMENS SCHWEIZ AG, Zürich (CH)

(21) Appl. No.: 12/159,402

(22) PCT Filed: Dec. 19, 2006
(86) PCT No.: PCT/EP06/12212

§ 371 Date: Jun. 27, 2008

(30) Foreign Application Priority Data
Dec. 29, 2005 (EP) 05028644.2

(51) Int. Cl. G06K 5/00

(52) U.S. Cl. 235/382

(57) ABSTRACT

Current electronic cards, such as, for example, proximity cards, smartcards for short, can transmit data to a reader unit over a range of up to about 10 cm. Boosters are used to improve convenience which in essence represent a wireless extension. This is however not adequate with regards to autonomy, function (as a result of termination) and for the differing applications. A method is disclosed in which the transmission of service-specific codes, stored on a number of different smartcards, to a portable device is carried out. The portable device then transmits one or more of the codes via several different communication connections so that access to a service can be activated. By providing services to the corresponding authorized communication connection a modular system is achieved, permitting multiple access for a user to services.

The present invention relates to a method for authorized granting of a service in accordance with the preamble of claim 1 and to a portable device for carrying out said method in accordance with the preamble of claim 11.

In this document the term “electronic card” or “electronic medium” or “medium” for short is generally taken to include electronic identity cards with an identifying characteristic, and these are also sometimes referred to by terms such as smartcard, chip card, electronic ticket, proximity cards, vicinity cards and employee badges. Proximity cards and vicinity cards are standardized by ISO, these standards being defined in ISO 14443 [1] and ISO 15693 [2], in addition the proximity cards and vicinity cards also include proprietary brands such as LEGIC prime for example.

The terms and definitions given in the list of abbreviations and acronyms are an integral part of this document in the sense of a glossary. This means that not all acronyms and terms are specifically explained elsewhere in the document. The widely-used English expressions have been employed both here and in the original German document within the text and in the glossary for the individual units. Likewise the function implemented with a component is in some cases provided with the same reference symbol as the component itself. To avoid any uncertainty, as in the original German version, the normally-used English expressions, such as. “challenge/response” are also employed in this translation for the individual units and methods.

Proximity Cards PICC can transmit data to a proximity card detector PCD at a range of between 1 and 10 cm. Thus, in order to be granted access to a zone, a person is obliged to move the card into the vicinity of the Proximity Card Detector PCD. This is especially disadvantageous when entering a garage since the window of the vehicle must be lowered to do so. There is especially the danger of the card falling on the floor when being manipulated in this way.

Personal identification details and/or authorizations are stored on a smartcard. The term identification details and/or authorizations also includes keys in the cryptographic sense. These identification details or authorizations, if necessary together with further interaction by a user, allow access to a location or allow a service or information to be obtained.

The term “service” in this document includes both the classical term from telecommunications, such as a supplementary service for example. The term “service” in this document is also understood to include any access to a location or to a service or for obtaining information or for obtaining money.

Smartcards possess an air interface, e.g. in accordance with ISO/IEC 14443 [1], and/or a contact interface, e.g. in accordance with ISO 7816 [3]. Both interfaces are designed for communication in the near field. In the case of a wireless connection this near field covers around 10 cm. Communication with such cards is not possible over a greater distance.

Chip card devices for accepting a chip card, with which a wireless connection to a terminal for a payment or access to an object is enabled are known for example from EP 0 159 539 A1 [9], U.S. Pat. No. 6,142,369 [10], U.S. Pat. No. 6,250,557 B1 [11] or DE 198 41 862 A1 [12]. In U.S. Pat. No. 6,250,557 B1 [11] there is provision, if a plurality of chip cards is inserted, for each chip card to be provided with its own IP address. In many cases a mobile telephone is provided as a chip card device, featuring slots for further chip cards, i.e. in addition to the SIM card slot.

For communication over greater distances, but not via a public switched telecommunication network such as GSM, so-called “combi boosters” are known, made by Nedap [4, 5] for example. A “booster” is an electronic portable device (=electronic wallet), into which a proximity card can be inserted. An identifier, mostly a personal identifier—referred to below as a “personified” identifier—is transferred from the proximity card via the air interface into the wallet. This wallet sends the received identifier on another frequency, e.g. on the ISM band of 2.45 GHz, to a static receiver unit. The received identifier is evaluated in a background system and, if the identifiers match, a release signal for granting access is generated. The wallet in this case can also contain a further identifier, so that access is only possible with the relevant wallet and the card. With the proprietary variant mentioned at the start it should be noted in this case that the connection cannot be terminated in the wallet unless a corresponding proprietary chip is built into the wallet. The reason for this the Layer 1/Layer 2 transmission used and not disclosed by scrambling.

Such a system is also desirable for access control in which a person carries such a wallet with an electronic card inserted into it. The above solution for parking lot entry is not satisfactory for further applications for the following reasons:
a) Autonomy is restricted or operation must be though an installation in a motor vehicle with wired energy supply.
b) Depending on the type of access implemented by radio technology, a correspondingly equipped electronic wallet must also be carried.

To grant an individual service, such as withdrawing cash from an ATM, a method is disclosed in 101 04 409 B4 [6] in which the ATM reads a code from the mobile telephone, preferably a bar code. This code contains a unique address for example, such as a MAC address for a first authentication for example. The further steps for dispensing the cash are undertaken via radio communication, e.g. via Bluetooth.

Such portable electronic devices have also already been proposed, such as in European Patent Application EP 05013418.8 [7] for example, in which the aforementioned disadvantage relating to the greatly restricted autonomy is remedied by “waking” of the electronic wallet by a near field. Following the “waking” with a first lower frequency of the portable electronic device there is intermittent bidirectional communication with an access point at a higher frequency. After a certain time without communication there can be provision for the portable device to return to the sleep state again. This enables a significantly great autonomy to be achieved.

The solution still does not satisfactorily remedy the disadvantage listed above under b), since this solution is restricted to a specific physical access and to a specific smartcard with a specific service.

The underlying object of the present invention is to create a method for a medium containing an identifier for granting a service, such as admission to a zone for example or for authorized use of service, with this method on the one hand overcoming the disadvantages stated above and also enabling the following:
Use for different types of electronic cards/media;
Usable for different cards of the same type, in which data/authorizations granted by an issuer are accessible in different ways, i.e. stored and/or accessible in separate segments;
Compatible with different interworking units;
Decoupling of the type of communication link from the authorization stored on the smartcard;
Simple handling by the user;
The safety mechanisms stored in the medium do not have to be disclosed.

The object of the invention is also to specify a portable device suitable for executing the above method.

This object is achieved for the method by the features specified in claim 1 and for the portable device by the features specified in claim 11.

The method defined in claim 1 provides a user with secure access to services in a modular manner. “Near field” of the first communication link means that the medium is in the direct vicinity within the range of up to a few millimeters from the portable device. By means of a plurality of media each containing at least one service-specific identifier service-specific authorization data can thus be requested for obtaining a service or for access to a zone. For a body issuing a medium such as a smartcard this has the advantage that the stored identifier assigned to a service can be administered independently of other identifiers. The function and the security are guaranteed despite the “portable device” vehicle because of the secure end-to-end connection, meaning that the portable device is not involved in the end-to-end data encryption. The bidirectional communication between the portable device and the access point makes it possible, with a conventional card reader located in the access point, for the card issued in the portable device to be emulated in the access point. On the one hand his allows existing access points to continue to be used and on the other hand the interface between access point and an assigned server or network management system does not have to be disclosed. This makes it possible to decouple access to a service from the actual means embodied for transmission to an access point such as a card reader for example.

In a development of the method an input means can be arranged on the portable device for authentication of the user based on a user interaction. A biometric sensor, e.g. a fingerprint sensor or keys can be arranged as the input means. The unit can be configured by means of entries made via the keys. Expediently a display is also to be provided, e.g. an LCD display. Both “challenges” and also “responses” for the authentication, which are needed for authentication of a user, can be shown on the display. The display also serves to display operating states relating to the portable device and also in relation to the granting of a service. The control elements are used not only for the above-mentioned authentication and/or configuring, but allow access to a possibly chargeable service based on an active deliberate action.

Further advantageous embodiments of the invention are specified in further claims.

The invention is explained in more detail below with reference to the drawing. The figures show:

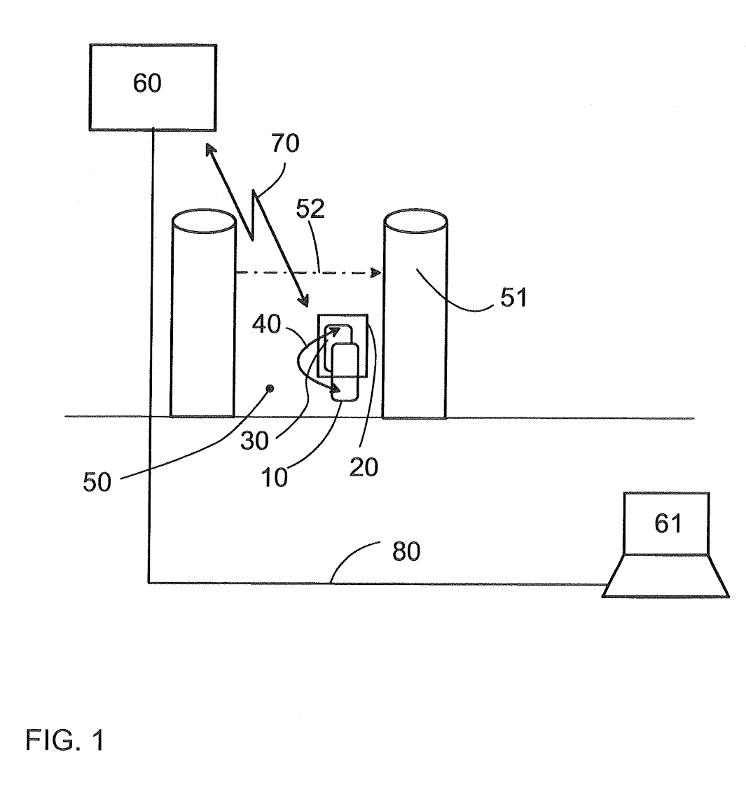

FIG. 1 spatial arrangement of the various functional units in a passage area;

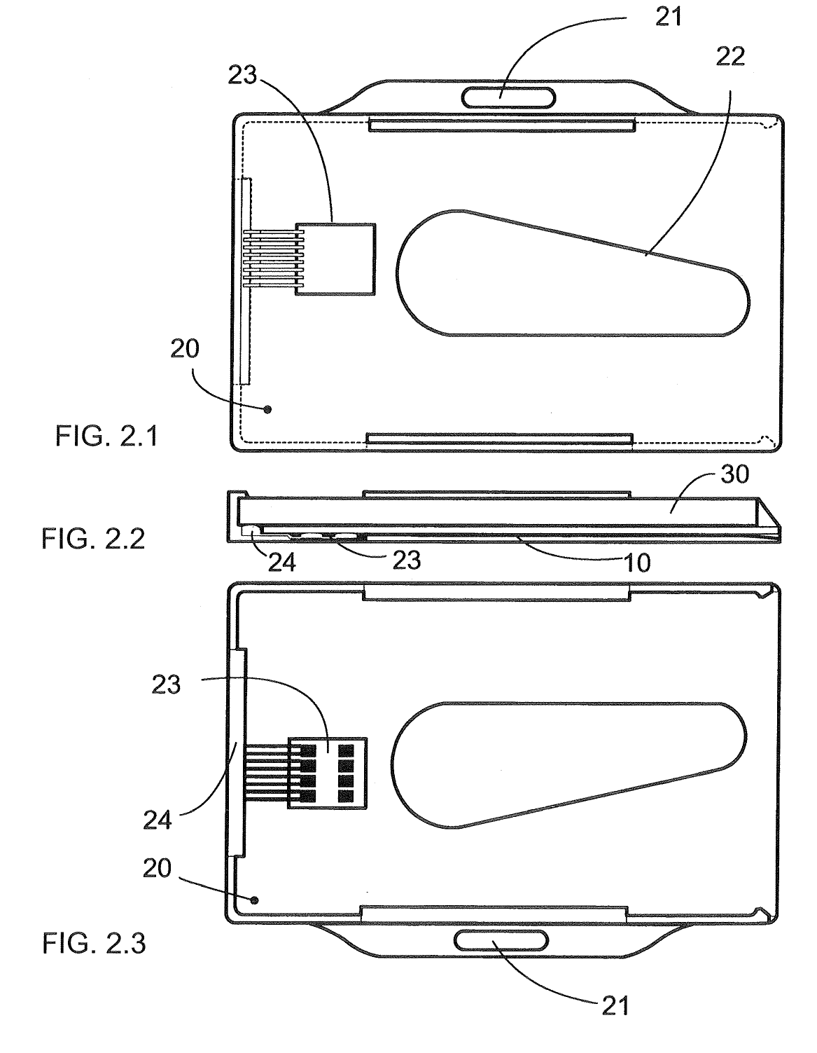

FIG. 2.1 front view of a wallet;

FIG. 2.2 cross section of a wallet and an assigned access point in a second embodiment;

FIG. 2.3 rear view/section of wallet;

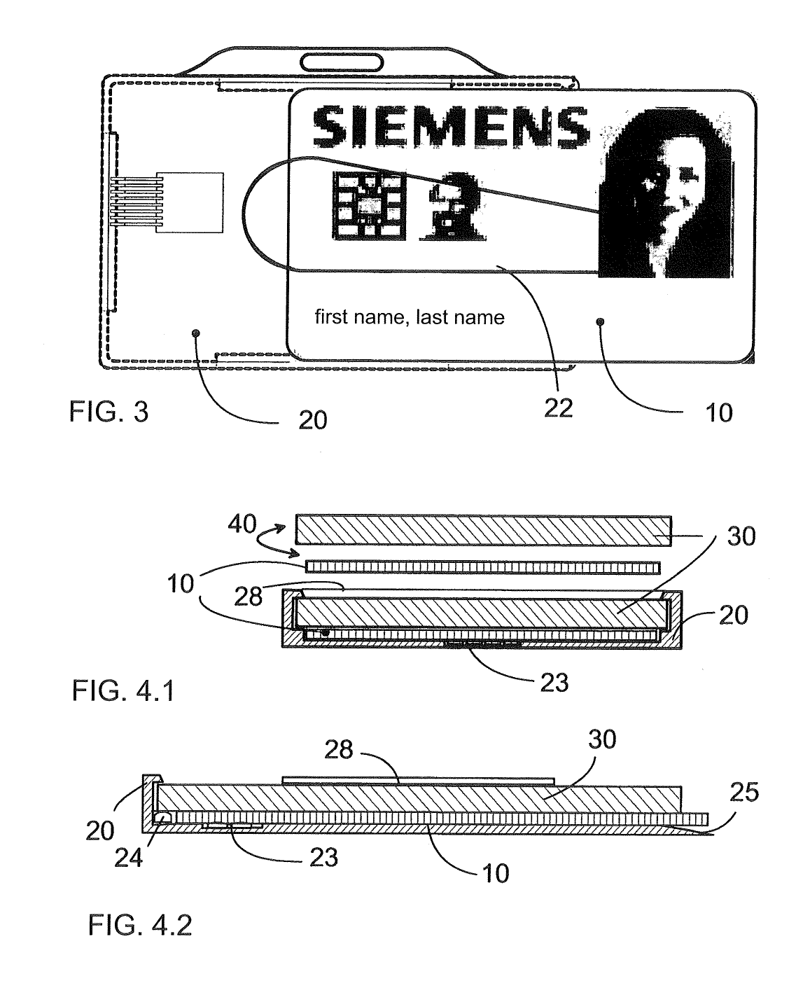

FIG. 3 Wallet with partially inserted card;

FIG. 4.1 exploded view of the basic components and mechanical design of the wallet in a cross section seen from the side;

FIG. 4.2 mechanical design in cross section from the longitudinal direction;

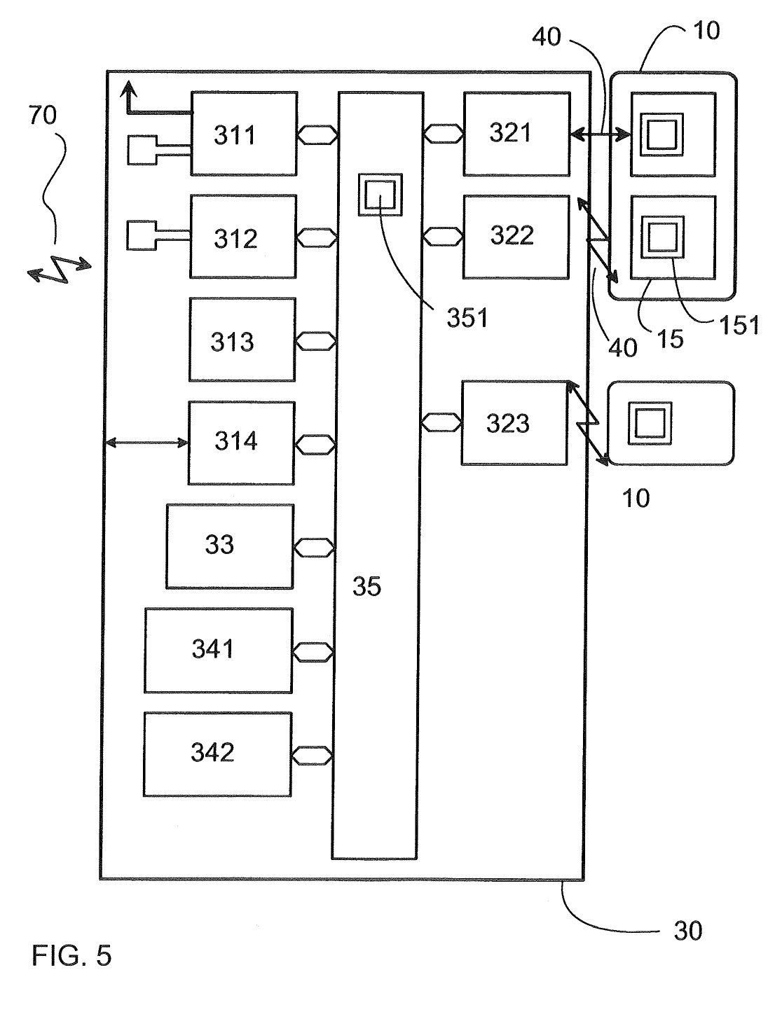

FIG. 5 block diagram of a portable device;

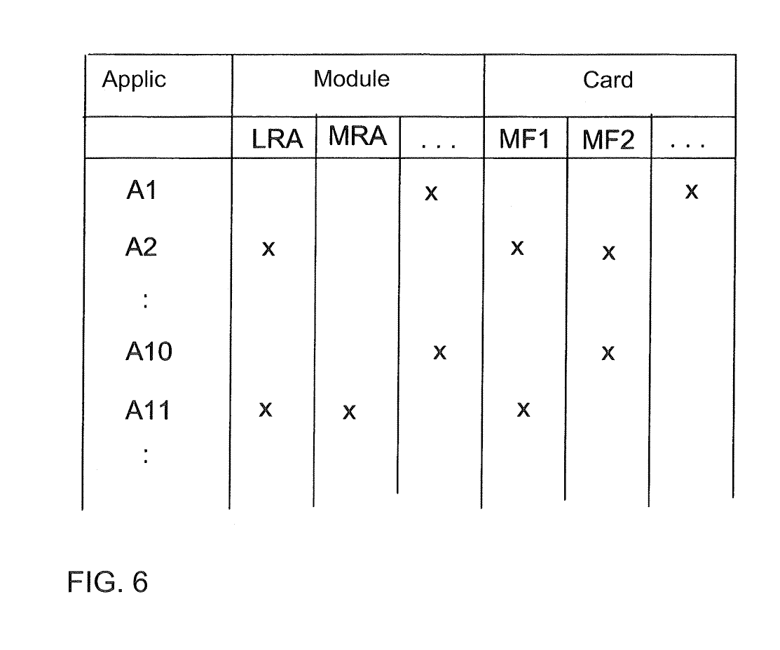

FIG. 6 diagram of the modular concept for the different services;

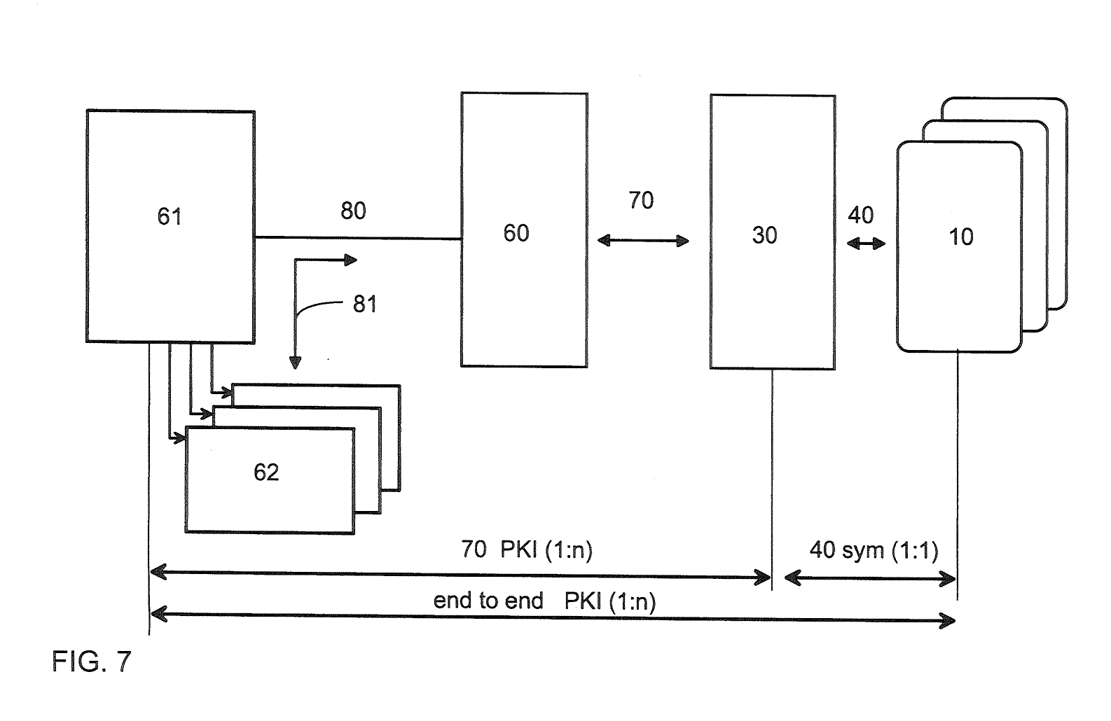

FIG. 7 diagram of secure communication links and the assignment of the services.

An overview of the principal function of the inventive method and of the components involved is given below with reference to FIG. 1. Details of the individual components and their function are then provided by subsequent FIGS. 2 to 7.

FIG. 1 shows the spatial arrangement of the different functional units or components in a passage area 50, which is formed by two entry pillars 51. An identifier located on the card 10 for access to a service is transmitted by a medium 10, preferably a smartcard 10, to the portable device 30 via a first secure communication link 40. The portable device 30 establishes a second communication link 70 to an access point 60. The aforementioned identifier and/or a further identifier are transmitted via this second likewise secure communication link 70 to the access point 60. The identifier transmitted in this way is evaluated via a connection 80 in a unit 61 located in the background, e.g. an authentication server 61, in order to establish on the basis of a comparison whether access can be granted in this way or whether a specific service may be obtained. The transmission of the identifier explained above never includes the transmission in clear text of only the identifier stored on the smartcard 10 under any circumstances. Instead a mapping (math.) of the identifier based on data encryption or based on a logical combination is transmitted. For encryption and authentication the appropriate keys and digital identity credentials are optionally stored on the portable device 30 and/or on the medium 10. The light barrier shown in FIG. 1 between the two entry pillars can for example serve to secure the data link of the zone 50 itself, to prevent a person being caught by an automatic door. Not explicitly shown are the actual variants of a service, such as delivery of digital goods such as a piece of music for example or access to specific information, etc. The figure also shows with optical interface 52 that, for a challenge/response, there is optical transmission to a portable device 30 on the basis of which a response is computed by a crypto controller in the device 30 and/or in the smartcard 10. In this case the portable device is to be held at this light barrier by the user. The actual embodiment of this optical interface is in this case of no significance for the present invention. In specific embodiments this optical interface can contain a section from a display on the entry pillars 51, so that with a pattern recognition implemented on the portable device a challenge can be read and a response computed in the way explained above. This type of information presentation on the display is referred to as “flickering”. The computation of the response can be undertaken in this case on the basis of an additional authentication of the user. Further information can be found in the explanation of FIG. 5. The challenge can however also be transmitted via the second radio communication link 70. A PKI-secured challenge-response protocol preferably executes between server 61 and medium 10. The smartcard 10 generates a response on the basis of the challenge. From the response, the server 61 detects the following:

I) That authorization exists for access to a service.
II) That the authorization is authentic.
III) That smartcard rightfully carries this authorization.
IV) That the response is current.

It is pointed out once more at this juncture that such a real access zone 50 in accordance with FIG. 1 only represents one example. The access point 60 can be coupled in an appropriate variant to a server 61 in order in this manner to allow the granting of a service as is shown in principle in FIG. 7. The access point 60 can also be embodied as a personal computer 60. In this case the above-mentioned optical interface can be realized with a section of the display of the personal computer 60. As a result of a successful authentication the server 61 for example grants access to a chargeable Internet page or for obtaining a specific material or immaterial service.

The wallet 20 only shown in summary in FIG. 1 is illustrated extensively in FIGS. 2.1, 2.2, 2.3, 3, 4.1 and 4.2. It is stated expressly at this point that this wallet 20 represents a useful vehicle for executing the inventive method, but that the wallet 20 is in no way a requirement.

The first communication link 40 between smartcard 10 and portable device can for example be made wirelessly in accordance with ISO 14443: To this end a person only needs to hold the smartcard 10 and the portable device together, as is shown in summary in the upper part of FIG. 4.1.

In especially sensitive zones there is even today a statuary duty to carry identification. To this end a wallet 20 is provided with a transparent cover 28 so that the picture assigned to a person is visible on the smartcard to third parties. The wallet 20, provided with portable device 30 and smartcard 10 can thus be worn visibly as an item of clothing. The mechanical design of the wallet 20 can be found in FIGS. 3, 4.1 and 4.2. The opening 22 as shown in FIG. 3 is used to make removal of the card 10 from the wallet 20 easier.

For the case in which an electrical connection such as that defined in ISO 7816 [3] for example is required between smartcard 10 and portable device 30, the wallet 20 depicted in FIGS. 2.1, 2.2, 2.3 and 3 provides the contacting for card 10 with a contact pad 23. The corresponding electrical contacting with the portable device 30 is undertaken via the contacts 24, which are preferably embodied sprung in order to ensure secure connection with a certain pressure. The wallet 20 does not have any other so-called intelligent electronics, but merely makes a reliable electrical connection.

In the case of a wireless connection between smartcard 10 and portable device 30 the wallet merely functions as a mechanical connection so that the two parts are protected against accidental loss.

In practical operation a user will establish a connection between different smartcards 10 and the portable device 30 in order to use the system. When a wallet 20 is used an insertion opening with a ramp 25 is provided which facilitates insertion.

FIG. 5 shows a block diagram of a portable device 30 in a preferred embodiment. In this case components such as energy supply and processor system, such as an 8051 single-chip processor for example, are not shown in detail. The above-mentioned first communication link 40 between smartcard 10 and device 30 is made on the one hand via an electrical interface unit 321 according to ISO 7816 for example. On the other hand an air interface unit 322, as defined in ISO 14443 for example, is provided. In this embodiment two crypto controllers 15 each with a Secure Application Module SAM 151 are arranged on the card. Communication is undertaken for example for the one controller 15 via contact interface unit 321 and for the other controller 15 via a radio interface unit 322 in the immediate near field.

Also arranged on the portable device 30 is a crypto controller 35 with at least one Secure Application Module SAM 351. These crypto controllers 15 and 35 provide a secure connection 40 between smartcard 10 and portable device 30 and also between portable device and access point 60. Contained in the crypto controller 15 for such an application can be a biometric authentication e.g. fingerprint details and/or keys for further biometric authentication methods. Likewise so-called digital identity credentials can be stored in the crypto controllers 15 and 35. A secure end-to-end connection in a form of tunneling is implemented between the crypto controller 15 between smartcard 10 and access point 60. The underlying methods can be found in the prior art, the security is preferably implemented using an asymmetrical PKI method or using the symmetrical so-called 3DES method. The communication link 70 between access point 60 and portable device 30 can be realized with:
Wide area interface 311, “Long Range Communication” with a two-stage transmission method, such as is disclosed in EP 1 210 693 B1 [8];
Air interface 312 “Short Range Communication” according to ISO 14443;
Optical Interface 313.

Instead of or in addition to the aforementioned radio interface in accordance with ISO 14443, an NFC interface can also be provided which includes the interface as defined in ISO 14443. At this juncture it is pointed out, to avoid misunderstandings, that the interface unit 312, as defined in ISO 14443 for example, has an entirely different function from the interface unit 322. In this way an emulation for card readers already installed is possible, without the relevant smartcard 10 having to be suitable for them, since this is dependent on the portable device 30 and not on the smartcard 10 coupled to the device at the time.

For interaction between a user and the portable device 30 the following are to be provided as an alternative or cumulatively:
Display 33;
Key or keypad 342;
Biometric sensor 341, e.g. fingerprint sensor.

The functional complexity contained in such a device requires configuration for most applications. This configuration is preferably undertaken via a wired interface unit 314, e.g. USB.

It is possible to use this wired interface in addition to or as an alternative to the second wireless communication link 70, e.g. for an access to service granted via a personal computer such as specific content of chargeable Internet pages.

The above modular system for access to the various services is shown in tabular form in FIG. 6. The Applic column uses the codes A1, A2, . . . to list potentially available services such as
Access to a building,
E-banking at a bank,
Access to an automatic teller machine,
Internet access to the pages of a specific provider,
Electronic tickets of a local rapid transit company,
A person's health data,
. . .

The physical communication links provided for each such service are now defined. The “permission carrier” of a relevant service is a specific smartcard MF1, MF2, . . . , on which an identifier specifying the personified service is contained. In this case there can be provision, provided this is allowed by the service providers, for a number of identifiers each specifying a service to be stored on a smartcard 10, each in their own section.

The above-mentioned assignment is either solely stored on the smartcard 10 or also stored on the portable device 30. As already stated, this assignment or configuration of the device is preferably undertaken via a wired interface unit 314 such as USB for example. In this way, for initiation of the use of a service the communication link type used for it is selected.

The functions of a card reader associated with classic technology can be freely distributed by the present disclosed embodiment of the invention between the portable device 30 and the access point 60 and thus allow a very flexible adaptation to the very widest range of applications, this relating in particular to the location of the so-called termination.

FIG. 7 shows the communication links and the associated services In a preferred embodiment. The services are either assigned to a plurality of smartcards 10 each with a service-specific code, or a smartcard 10 contains a plurality of such service-specific codes. The transmission 40 between smartcard 10 and portable device is mostly secured using a symmetrical data encryption since there is a 1:1 relationship for this. By contrast the communication link 70 from the portable device via the access point 60 to server 61 is secured with a PKI method since a 1:n relationship exists here. As a result of the two secured connections 40 and 70 there is thus a secure end-to-end protocol between the smartcard 10 and the server 61. There is no contradiction here, if the reference symbol 70 is used for the connection between server 61 and device 30, since the access point 60 generally only has a transit function, i.e. neither access authorizations are checked within it nor are any precautions taken to secure the connection. As a result of the above check, i.e. authentication, a release signal is issued by the server 61 to the relevant service server 62. The service in this case is allocated to the user or granted via a connection 81. This service can be provided in a diversity of ways and is therefore shown in FIG. 7 only in a very rudimentary manner. The connection 70 can however optionally be established to an access point 60 in the near field for a specific service. For this purpose the block diagram in accordance with FIG. 5 contains an interface 312 as defined in ISO 14443.

The present invention is implemented with a very wide variety of card systems such as Legic or Mifare for example. It can also be used for different cards of the same system, namely if the difference only relates to the issuer or the owner of the card.

### LIST OF REFERENCE SYMBOLS USED, GLOSSARY

10 Electronic card, chip card, proximity card, vicinity card; Medium
15 Crypto controller resident on the card 10
151 Secure Application Module SAM assigned to the crypto controller
20 Wallet for accepting a card 10 and a module 30
21 Opening for an attachment element, e.g. clips
22 Opening for ejecting the card 10
23 Contact pad, e.g. for contacting a card 10 in accordance with ISO 7816
24 Contacts for contacting of a module 30
25 Insertion opening, ramp for easier insertion of a card
28 Cover, transparent cover
30 Portable device, transceiver unit, module, communication module for physical access, token
311 Wide area radio interface, “long range”
312 Interface according to ISO 14443 or NFC interface
313 Optical interface
314 Wired interface, e.g. USB
321 Wired interface for smartcard 10, e.g. according to ISO 7816
322 Interface for smartcard 10, e.g. according to ISO 1443
323 Optional further interface to other medium 10
33 Display, e.g. realized as LCD display
341 Biometric sensor, e.g. fingerprint sensor
342 Key, keypad
35 Crypto controller
351 Secure Application Module SAM assigned to the crypto controller
40 First communication link
50 Passage zone, passage area
51 Pillar
52 Light barrier
60 Personal computer access point
61 Server background system, computer system, Network management system for evaluation of the code and for generation of a release signal for granting a service
62 Service server, server system containing the services to be provided
70 Second communication link, bidirectional communication
80 Connection between access point 60 and server 61
A1, A2, Actual variants of a service, for example
   Electronic ticketing,
   Building access,
   E-commerce over the Internet,
   E-banking service of a bank,
   etc.
Applic service, application
LRA Long Range Access
MF1, MF2, . . . Mifare card 1, Mifare card 2,
MRA Mid Range Access
SAM Secure Application Module

### LIST OF ACRONYMS USED

3DES Triple DES
DES Data Encryption Standard, standardized private key method as defined in ANSI-X3.92-1981
GSM Global system for Mobile Communication
NFC Near Field Communication in accordance with http://www.nfc-forum.org
PCD Proximity Coupling Device; in accordance with ISO 14443
PICC Proximity Cards; in accordance with ISO 14443
PKI Public KEY Infrastructure
SIM Subscriber Identity Module
USB Universal Serial Bus

### LITERATURE LIST

[1] ISO/IEC 14443-1
   Identification cards—Contactless integrated circuit(s) cards—Proximity cards—
   Part 1:
   Physical characteristics
   ISO/IEC 14443-2
   Identification cards—Contactless integrated circuit(s) cards—Proximity cards—
   Part 2:
   Radio frequency power and signal interface
[2] ISO/IEC 15693-1
   Identification cards—Contactless integrated circuit(s) cards—Vicinity cards—
   Part 1:
   Physical characteristics
   ISO/IEC 15693-2
   Identification cards—Contactless integrated circuit(s) cards—Vicinity cards—
   Part 2:
   Air interface and initialization
   ISO/IEC 15693-2
   Identification cards—Contactless integrated circuit(s) cards—Vicinity cards—
   Part 3:
   Anticollision and transmission protocol
[3] ISO/IEC 7816-1
   Identification cards—Integrated circuit(s) cards with contacts—
   Part 1:
   Physical characteristics
   ISO/IEC 7816-1
   Identification cards—Integrated circuit(s) cards with contacts—
   Part 2:
   Dimensions and Location of the contacts
[4] Nedap N. V. NL-7140 AC Groenlo.
[5] EP 0 575 013 A1
   System for the contactless exchange of data, and responder for use in such a system
   N.v Nederlandsche Apparatenfabriek NEAP.
[6] DE 101 04 409 A1, DE 101 04 409 B4
   Connection selection using an optical code WINCOR NIXDORF International GmbH, 3106 Paderborn.
[7] European Patent Application EP 05013418.8 Applicant:
   Siemens Schweiz AG
   Application date: 22 Jun. 2005
   Title: Method, electronic wallet and access point for granting access to a zone with a card.
[8] EP 1 210 693 B1
   Method and System for registration of tickets Siemens VDO Automotive AG, CH-8212 Neuhausen am Rheinfall.
[9] EP 0 159 539 A1
   Chip card system
   Siemens Aktiengesellschaft Berlin and Munich.
[10] U.S. Pat. No. 6,142,369
   Electronic Transaction terminal for conducting electronic financial transactions using a Smart Card Assignee: AU-system, Stockholm
[11] U.S. Pat. No. 6,250,557 B1
   Methods and arrangements for a Smart Card wallet and uses thereof.
   Assignee: Telefonaktiebolaget LM Ericsson, Stockholm.
[12] DE 198 41 862 A1
   Integration of chip card functions into a mobile communication device
   Wieland, Andreas, DE 57076 Siegen DE.

1-16. (canceled)

17. A method for an authorized granting of a service, selected from the group consisting of granting access to a location, granting access for obtaining information, and granting access for obtaining cash, using an electronic medium storing authorization for a specific service having a specific-service identifier, which comprises the steps of:
establishing a first secured communication link between a portable device and the electronic medium for at least one of a plurality of service-specific identifiers stored on the electronic medium and a plurality of different types of media, so that for each said service a secured end-to-end connection will be set up between an access point and the electronic medium;
transmitting the service-specific identifier over the first secured communication link between the electronic medium and the portable device in a near field;
transmitting the service-specific identifier over a second secured communication link between the portable device and the access point; and
creating a release signal for granting the service if there is a match between the service-specific identifier received by the access point and a stored identifier.

18. The method according to claim 17, which further comprises checking for a match between the service-specific identifier received by the access point and the stored identifier stored in a server coupled to the access point.

19. The method according to claim 18, which further comprises:
storing further identifier in the portable device;
transmitting the further identifier via the second secured communication link; and
generating the release signal only if the further identifier matches a stored further identifier.

20. The method according to claim 19, which further comprises providing a input means on the portable device, so that the further identifier is only transmitted via the second secured communication link if a code is entered via the input means and it is established that the code matches a stored code.

21. The method according to claim 20, which further comprises:
storing the stored code in one of the portable device, the access point and the server; and
modifying at least one transmitted service-specific identifier in relation to the stored identifier as a result of an authentication.

22. The method according to claim 19, which further comprises forming the further identifier in accordance with a challenge-response method.

23. The method according to claim 20, which further comprises forming the code entered using a biometric method.

24. The method according to claim 17, which further comprises providing the portable device with a plurality of air interfaces and selecting the second secured communication link from the plurality of air interfaces depending on the service defined by the service-specific identifier.

25. The method according to claim 17, which further comprises establishing the first secured communication link at least one of electrically and wirelessly.

26. The method according to claim 17, which further comprises establishing the first and second secured communication links according to one of a PKI method and a 3DES method.

27. An electronic portable device, comprising:
at least one interface unit for routing a first secure communication link in a near field to a medium containing an identifier;
at least one air interface unit for routing a second secure communication link to an access point;
a crypto controller connected to said interface unit and to said air interface unit;
a service-specific identifier being transmitted from the medium to the access unit for an authorized granting of a service and, if the service-specific identifier received by the access unit matches a stored identifier, a release signal for granting the service being generated; and
the first communication link connected between said at least one interface unit and the medium is able to be established for a plurality of service-specific identifiers stored on the medium and/or for a plurality of different types of media, so that a secure end-to-end connection is able to be set up by use of said crypto controller for each service between the medium and the access point.

28. The device according to claim 27, further comprising input means coupled to said crypto controller to carry out an authentication of a person assigned to the service-specific identifier or to set a specific operating state.

29. The device according to claim 28, wherein said input means is selected from the group consisting of a keypad and a biometric sensor and is coupled to said crypto controller.

30. The device according to claim 29, wherein said biometric sensor is a fingerprint sensor.

31. The device according to claim 27, further comprising a display coupled to said crypto controller on which operating states, challenges, and responses are able to be displayed.

32. The device according to claim 27, further comprising at least one wired interface allowing configuration data to be transmitted to the device.
